(19) United States
(12) Patent Application Publication
(10) Pub. No.: US 2014/0149430 A1
(43) Pub. Date: May 29, 2014

(54) METHOD OF DETECTING OVERLAPPING COMMUNITY IN NETWORK

(71) Applicants: Korea Advanced Institute of Science and Technology, Daejeon-si (KR); Samsung Electronics Co., Ltd., Suwon-si (KR)

(72) Inventors: Seungwoo RYU, Seoul (KR); Sejeong KWON, Daejeon-si (KR); Jae-Gil LEE, Daejeon-si (KR); Sungsu LIM, Daejeon-si (KR)

(21) Appl. No.: 13/930,069

(22) Filed: Jun. 28, 2013

(30) Foreign Application Priority Data
Nov. 28, 2012 (KR) 10-2012-0136396

(51) Int. Cl. G06F 17/30

(52) U.S. Cl. CPC G06F 17/3053
USPC 707/749

(57) ABSTRACT

A method of detecting an overlapping community in a network including nodes and links between the nodes, includes calculating a similarity between the links, and generating a line graph of the network. The method further includes detecting one or more cores in the line graph, and growing a cluster for each of the one or more cores. The method further includes converting the cluster into a cluster of nodes of a node graph.

### CROSS REFERENCE TO RELATED APPLICATION

This application claims the benefit under 35 USC 119(a) of a Korean Patent Application No. 10-2012-0136396, filed on Nov. 28, 2012, in the Korean Intellectual Property Office, the entire disclosure of which is incorporated herein by reference for all purposes.

### BACKGROUND

1. Field

The following description relates to a method of detecting an overlapping community in a network.

2. Description of the Related Art

In real-world social network services, individuals generally belong to a large number of communities (e.g., families, friends, co-workers, and classmates). In order to define a community structure in a network, clustering techniques based on a node graph and clustering techniques based on a line graph may be used. However, a great deal of research has been focused on solving a graph partitioning problem when a separated community is identified within a given network.

In spite of the great deal of research, it may be difficult to derive a clustering technique of defining an overlapping community structure in a social network or an information network in which one node may belong to a plurality of communities. For example, when a number of overlapping nodes commonly belonging to a plurality of communities is large, there may be a problem in that it is difficult to perform clustering. In some cases, there may be a problem in that a clustering result differs whenever clustering is performed.

### SUMMARY

In one general aspect, there is provided a method of detecting an overlapping community, including calculating a similarity between the links, and generating a line graph of the network. The method further includes detecting one or more cores in the line graph, and growing a cluster for each of the one or more cores. The method further includes converting the cluster into a cluster of nodes of a node graph.

In another general aspect, there is provided a method of detecting an overlapping community, including generating a line graph of the network, and detecting one or more cores in the line graph. The method further includes growing a cluster for each of the one or more cores, and calculating a similarity between the links. The method further includes converting the cluster into a cluster of nodes of a node graph.

Other features and aspects will be apparent from the following detailed description, the drawings, and the claims.

### BRIEF DESCRIPTION OF THE DRAWINGS

FIG. 1 is a flowchart illustrating an example of a method of detecting an overlapping community.

FIG. 2 is a diagram illustrating an example of a node community, an outlier, and a hub.

FIG. 3 is a diagram illustrating an example of a method of calculating a similarity between links.

FIG. 4 is a diagram illustrating an example of a link community after a method of calculating a similarity between links is performed.

FIG. 5 is a flowchart illustrating another example of a method of detecting an overlapping community.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

A line graph is used in a method of converting a link connected between nodes in a graph G into a form of a node in the line graph and representing all links adjacent to the link in the graph G as adjacent nodes. The line graph is referred to as a line graph framework. Hereinafter, in order to avoid a confusion of terminology, the graph G is represented as a node graph, and the node of the line graph is represented as a vertex.

Among analysis methodologies based on a link of a network, a link partition technique is an overlapping clustering technique of performing clustering in a random walk scheme on a line graph framework. On the other hand, a structural clustering algorithm for networks (SCAN) technique is a clustering technique capable of identifying a hub and an outlier as well as a community structure in a graph.

In addition, a link-link similarity measurement technique is a method of calculating a structural similarity between links. Also, there is a method of detecting an overlapping community using the above-described similarity. In the method of detecting an overlapping community as will be described later, some of clustering methodologies presented by the line graph framework, the SCAN clustering technique, and the link-link similarity measurement technique are modified and utilized.

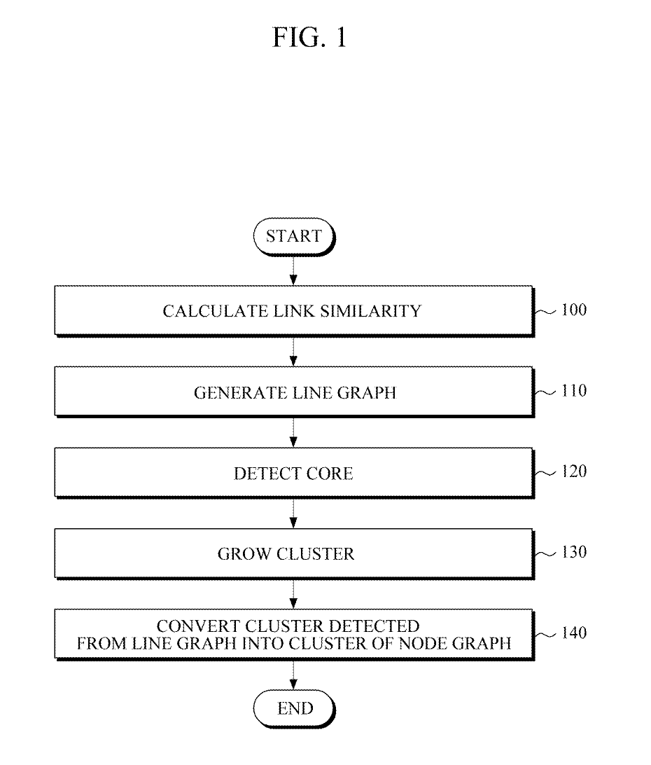

FIG. 1 is a flowchart illustrating an example of a method of detecting an overlapping community. One target pursued by the method of detecting an overlapping community is to provide a method of detecting an overlapping node in a given network.

When a node belongs to two or more communities, the node is represented to be overlapped. That is, if an individual corresponding to the node includes a heterogeneous membership to two or more communities, there are various neighbors according to a type of membership of a community to which the individual belongs. Accordingly, there is no unreasonableness even when a node of which neighboring nodes include different memberships is assumed to be an overlapping node.

Next, a meaning of neighboring nodes including different memberships will be described. If there is common interest or common membership between two nodes in a real-world network, there is a link between one pair of nodes. Accordingly, a relationship between two nodes is determined according to a type of link connected therebetween. In this point of view, a relationship between links is used to identify an overlapping node.

A line graph framework may be used to easily deal with the relationship between the links. Each link includes a relation to form a link cluster of links in a network. Each cluster is formed by a set of nodes including the same membership of the links in the network. An existing link partition technique is disadvantageous in that an excessive number of overlapping nodes belonging to a plurality of communities may be generated because it may be difficult to define community memberships allocated to some links in the links.

The method of detecting an overlapping community of FIG. 1 solves the above-described disadvantage by dividing links within a network into a link community and others. The others are an outlier and a hub.

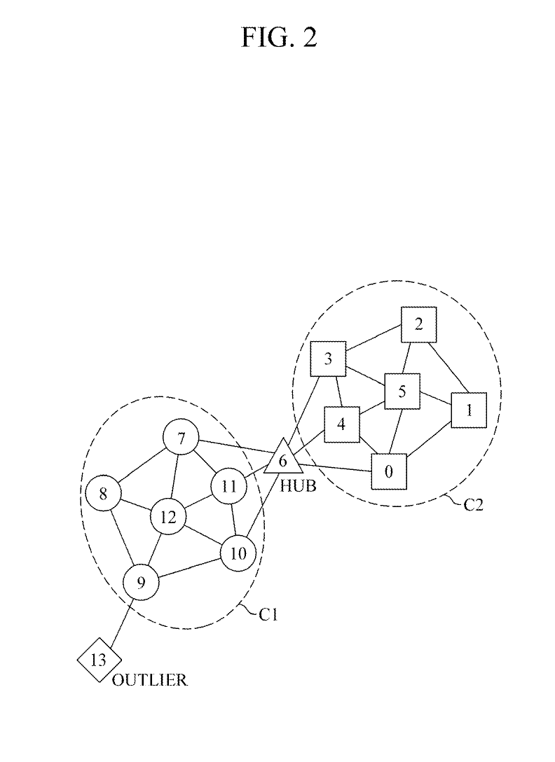

FIG. 2 is a diagram illustrating an example of a node community, an outlier, and a hub. As illustrated in FIG. 2, a node community C1 in a node graph is a community of nodes 7 to 12 including the same membership, and a node community C2 in the node graph is a community of nodes 0 to 5 including the same membership. An outlier node 13 rarely or never affects data because the outlier node 13 is not similar to other links. In addition, a hub node 6 connects the node communities C1 and C2 due to the hub node 6 including two or more similar memberships of communities, but does not belong to any community.

When clustering is performed using the existing SCAN technique, it is possible to detect an outlier and a hub within a network. That is, nodes within the network may be nodes within a node set, and the nodes may be classified as hub nodes or outlier nodes. When the existing SCAN technique is used, a core node and structure connectivity may be defined in association with a similarity measure. Accordingly, it is possible to efficiently find community membership for each node.

With reference back to FIG. 1, the method of detecting an overlapping community includes calculating a link similarity (100), generating a line graph (110), detecting a core (120), growing a cluster (130), and converting the cluster detected from the line graph into a cluster of a node graph (140). Operation 140 also includes excluding an unnecessary vertex.

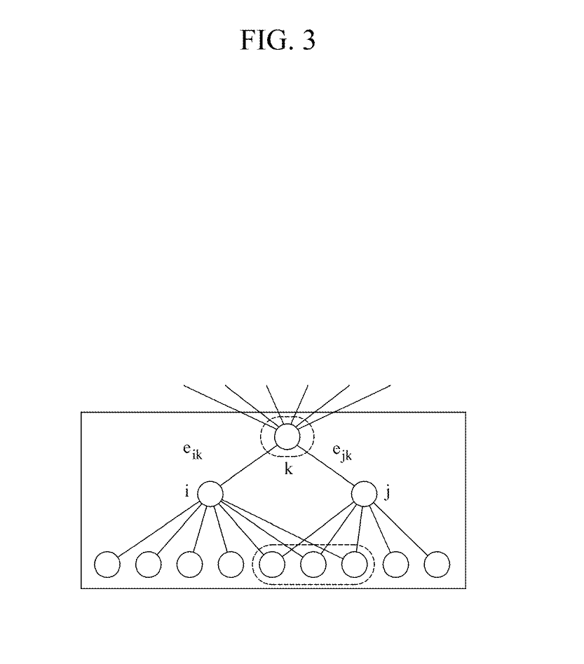

In operation 100, a similarity between each pair of links in the node graph is calculated. For example, a similarity between a link e_{i,k} and a link e_{j,k} is calculated when there are nodes i, j, and k in a node graph as illustrated in FIG. 3 described herein.

FIG. 3 is a diagram illustrating an example of a method of calculating a similarity between links. A node graph includes nodes i, j, and k. A link e_{i,j} is between the nodes i and k, and a link e_{j,k} is between the nodes j and k. A similarity between the links e_{i,k} and e_{j,k} is calculated.

Referring again to FIG. 1, the link similarity is calculated because a method using structural similarity is not applicable to the existing SCAN technique. That is, when the cluster is grown using a method similar to the existing SCAN technique in operation 130, a problem of erroneous community detection occurs because of different line graph characteristics.

Accordingly, a disadvantage of the structural similarity is removed by calculating a similarity between links using a link-link similarity measurement technique in operation 100. Thereafter, a link below a fixed similarity level (threshold link similarity), for example, a point serving as an outlier, is set to be excluded in operations 120 and 130.

In operation 100, S(e,ik, eⱼₖ) representing the similarity between a pair of the links eᵢₖ and eⱼₖ may be represented as shown in the following example of Equation (1):

$$S ( {e}_{ik} , {e}_{jk} ) = \frac{\vert Γ ( i ) ⋂ Γ ( j ) \vert}{\vert Γ ( i ) ⋃ Γ ( j ) \vert} \qquad ( 1 )$$

In addition, a similarity between links not meeting each other becomes 0.

In operation 110, the line graph is generated from the node graph. That is, the node graph is converted into the line graph so that a link within the node graph of a target network is represented in a form of a node in the line graph. Hereinafter, in order to avoid a confusion of terminology, a node in the line graph into which a link of the node graph is converted will be referred to as a vertex.

In operation 120, the core is detected from the line graph. That is, at least one core vertex is detected from vertices in the line graph.

In operation 130, the cluster is grown in the line graph. That is, the cluster including vertices of the same membership is grown for every core vertex in the line graph. In more detail, a cluster identifier (ID) distinguished for every core vertex is assigned to each of core vertices. In addition, a vertex neighboring a core vertex and including a similarity to the core vertex that is greater than a threshold value, among unlabeled vertices of neighboring vertices of each core vertex, is assigned the same cluster ID as that of the core vertex.

In operation 140, the cluster detected from the line graph is converted into the cluster of the node graph. Because the cluster detected from the line graph is a cluster of vertices or links (e.g., a link cluster), the cluster detected from the line graph is converted into a form of a cluster of nodes (e.g., a node cluster) of the node graph.

In this example, a vertex including a link similarity to a core vertex that is lower than the threshold link similarity is not assigned a cluster ID in the operation in which each cluster is grown because the link similarity is low. Accordingly, no cluster ID is assigned to a vertex with a low link similarity. A vertex to which no cluster ID is assigned may be labeled as a non-member. In addition, a vertex labeled as a non-member may be excluded in the conversion of a link cluster into a node cluster.

On the other hand, a core may need to be newly-determined so as to apply the SCAN technique to the method of detecting an overlapping community of FIG. 1. In the SCAN technique to be used in a node graph, a node n may be determined to be a core when a number of neighboring nodes including at least a similarity of ε to the node n is greater than or equal to a predetermined threshold μ for the node n.

On the other hand, in this example, in a line graph, a vertex υ is determined to be a core vertex when a ratio of neighboring vertices including at least a similarity of a predetermined threshold ε (referred to as a threshold link similarity) for the vertex υ, to all neighboring vertices thereof is greater than or equal to a predetermined threshold μ (referred to as a threshold link relation ratio). That is, while a core vertex based on the existing SCAN technique is determined according to a number of links exceeding a similarity greater than or equal to a threshold value ε, a core vertex based on the method of detecting the overlapping community of FIG. 1 is determined according to a ratio of links exceeding the similarity greater than or equal to the threshold value ε.

A core in the method of FIG. 1 is determined differently from the existing SCAN technique because characteristics of a converted graph differ. Also, it is difficult to determine whether a vertex is a core vertex using a minimum number of the predetermined threshold μ in the SCAN technique.

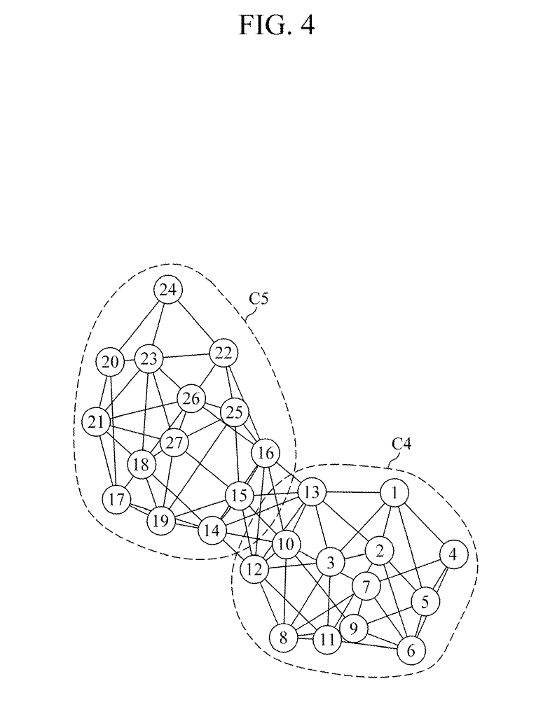

FIG. 4 is a diagram illustrating an example of a link community after a method of calculating a similarity between links is performed. That is, FIG. 4 is a diagram obtained by modifying the node graph of FIG. 2 into a line graph including link communities or clusters C4 and C5 after a link-link similarity measurement technique is applied to the node graph. A vertex to which no cluster ID is assigned becomes a non-member and is an outlier or hub vertex. It is possible to detect the clearly-divided link clusters C4 and C5 by applying the similarity measurement technique to vertices 1 through 24 of the line graph.

Referring again to FIG. 1, in operation 140, the detected link cluster is converted into the form of the cluster formed by the nodes of the node graph. For example, in a link graph, there may be a vertex V₁ (=e_{i,k}) (a link connecting a node i and a node k) and a vertex V₂ (=e_{j,k}) (a link connecting a node j and the node k), V₁ belongs to a link cluster No. 1, and V₂ belongs to a link cluster No. 2. Accordingly, after converting the link clusters No. 1 and 2 into clusters No. 1 and 2 formed by the nodes i, j, and k, respectively, the node i and the node k belong to the cluster No. 1, and the node j and the node k belong to the cluster No. 2. Accordingly, k belongs to the cluster Nos. 1 and 2, and consequently, is represented to be overlapped.

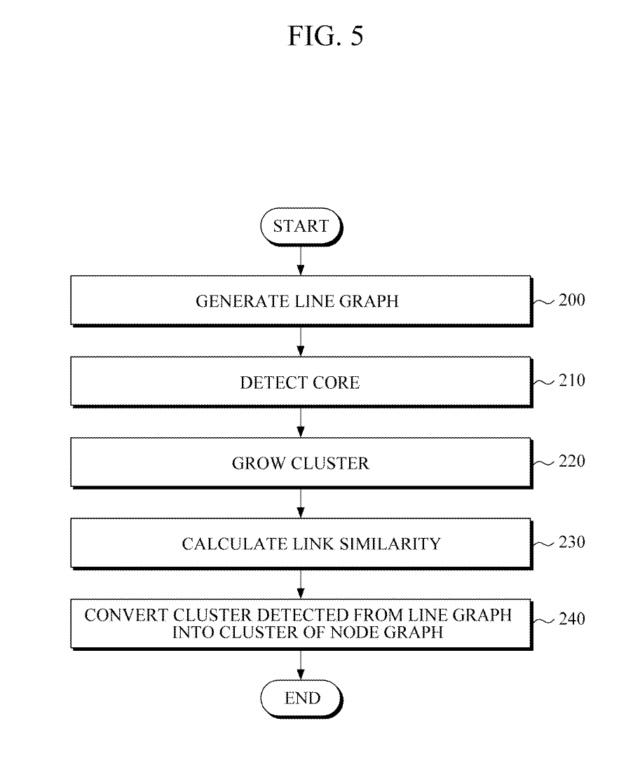

FIG. 5 is a flowchart illustrating another example of a method of detecting an overlapping community. As illustrated in FIG. 5, the method may be applied to a network including a plurality of nodes and a plurality of links. The method includes generating a line graph of the network (200), detecting a core included in the line graph (210), growing a cluster from the line graph (220), calculating a link similarity between different links (230), and converting the cluster detected from the line graph into a cluster of a node graph (240).

In more detail, in operation 200, the line graph is generated from the node graph.

In operation 210, at least one core vertex is detected from vertices in the line graph.

In operation 220, the cluster including vertices of the same membership is grown for every core vertex in the line graph. In more detail, a cluster ID distinguished for every core vertex is assigned to each core vertex. In addition, a vertex neighboring a core vertex and including a similarity to the core vertex that is greater than a threshold value, among unlabeled vertices of neighboring vertices of each core vertex, is assigned the same cluster ID as that of the core vertex.

In operation 230, a similarity between links intersecting each other, e.g., the link eᵢₖ and the link eⱼₖ when the nodes i, j, and k are arranged as illustrated in FIG. 3, is calculated.

In operation 240, the link cluster detected from the line graph is converted into the cluster formed by nodes of the node graph. Because the link cluster detected from the line graph is a cluster of vertices or links, the link cluster needs to be converted in a form of the cluster of the nodes of the node graph. In addition, a vertex including a link similarity to a core vertex that is lower than a threshold link similarity is not assigned a cluster ID in the operation in which each cluster is grown because the link similarity is low. Accordingly, no cluster ID is assigned to a vertex with a low link similarity. As described above, a vertex to which no cluster ID is assigned may be labeled as a non-member. In addition, a vertex labeled a non-member may be excluded in the conversion of a link cluster into a node cluster.

The order in which the calculating of the link similarity is performed is different between the method of FIG. 1 and the method of FIG. 5. In the method of FIG. 1, operation 100 of calculating the link similarity is performed before operation 110 of generating the line graph. On the other hand, in the method of FIG. 5, operation 230 of calculating the link similarity is performed after or when operation 220 of growing the cluster. When operation 100 of calculating the link similarity is first performed as illustrated in FIG. 1, unnecessary iterative calculation may be avoided. Consequently, it is possible to expect an improvement of a calculation speed.

On the other hand, when a good threshold link similarity ε is determined after a threshold relation ratio is arbitrarily determined, heuristics may be used. The following is an example of the heuristics.
(1) A predetermined threshold μ is fixed to a value so as to select the good threshold link similarity ε.
(2) Nodes of about 10% are extracted from all nodes of a graph, and all similarities of the extracted nodes are arranged in descending order.
(3) A μ^{th} index (an index of the top μ %) is obtained by multiplying a total length of arranged similarity values of the extracted nodes by μ.
(4) A value corresponding to an index of each node is selected and stored as a representative value.
(5) After the above calculation is completed, stored values are arranged.

Arranged representative values are represented by a graph, and a corresponding similarity ε is selected by selecting a point serving as a knee.

In addition, the threshold link similarity ε may be automatically selected. The following is an example in which the threshold link similarity is automatically selected.
(1) After the above-described heuristic process at the selected μ, values arranged with the ε value are received as resulting values.
(2) Because scales of x and y axes are different, normalization is performed based on largest values on the x and y axes.
(3) After rotational conversion at 45 degrees in a clockwise direction, a regression process or a peak detection method is performed.
(4) When the regression process is performed, an index in which a value of 0 is calculated is selected by performing differentiation. When the peak detection method is performed, an index of a peak point is found by dividing values of the x axis into specified fixed sections, obtaining an average, and performing peak detection.
(5) A candidate for the threshold link similarity E corresponding to the index is selected.

The various elements and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of detecting an overlapping community in a network comprising nodes and links between the nodes, comprising:
calculating a similarity between the links;
generating a line graph of the network;
detecting one or more cores in the line graph;
growing a cluster for each of the one or more cores; and
converting the cluster into a cluster of nodes of a node graph.

2. The method of claim 1, wherein each of the one or more cores is a vertex of the line graph that comprises a ratio between a number of neighboring vertices comprising a similarity to the vertex that exceeds a predetermined similarity and a total number of neighboring vertices, that is greater than a predetermined ratio, among vertices of the line graph that correspond to the links.

3. The method of claim 2, further comprising:
fixing the predetermined ratio to a value; and
determining the predetermined similarity based on the predetermined ratio.

4. The method of claim 1, wherein the growing comprises:
assigning a cluster identifier (ID) distinguished for each of the one or more cores to each of the one or more cores; and
assigning the same cluster ID of a core to a neighboring vertex comprising a similarity to the core that is greater than a predetermined similarity, for each of one or more neighboring vertices of each of the one or more cores.

5. The method of claim 4, wherein the converting comprises:
labeling a vertex to which the cluster ID is unassigned as a non-member, among the one or more neighboring vertices.

6. The method of claim 4, wherein the converting comprises:
excluding a vertex to which the cluster ID is unassigned, among the one or more neighboring vertices.

7. The method of claim 1, wherein the calculating comprises:
calculating a similarity of each of pairs of the links.

8. The method of claim 7, wherein the detecting comprises:
detecting the one or more cores in the line graph based on the similarity of each of the pairs of the links.

9. The method of claim 7, wherein the growing comprises:
growing the cluster of the links for each of the one or more cores based on the similarity of each of the pairs of the links.

10. A non-transitory computer-readable storage medium storing a program comprising instructions to cause a computer to perform the method of claim 1.

11. A method of detecting an overlapping community in a network comprising nodes and links between the nodes, comprising:
generating a line graph of the network;
detecting one or more cores in the line graph;
growing a cluster for each of the one or more cores;
calculating a similarity between the links; and
converting the cluster into a cluster of nodes of a node graph.

12. The method of claim 11, wherein each of the one or more cores is a vertex of the line graph that comprises a ratio between a number of neighboring vertices comprising a similarity to the vertex that exceeds a predetermined similarity and a total number of neighboring vertices, that is greater than a predetermined ratio, among vertices of the line graph that correspond to the links.

13. The method of claim 11, wherein the growing comprises:
assigning a cluster identifier (ID) distinguished for each of the one or more cores to each of the one or more cores; and
assigning the same cluster ID of a core to a neighboring vertex comprising a similarity to the core that is greater than a predetermined similarity, for each of one or more neighboring vertices of each of the one or more cores.

14. The method of claim 13, wherein the converting comprises:
labeling a vertex to which the cluster ID is unassigned as a non-member, among the one or more neighboring vertices.

15. The method of claim 13, wherein the converting comprises:
excluding a vertex to which the cluster ID is unassigned, among the one or more neighboring vertices.

16. A non-transitory computer-readable storage medium storing a program comprising instructions to cause a computer to perform the method of claim 11.
